(19) United States
(12) Patent Application Publication
(10) Pub. No.: US 2025/0385696 A1
(43) Pub. Date: Dec. 18, 2025

(54) ANTENNA SHARING FOR CHANNEL SOUNDING APPLICATIONS

(71) Applicant: HEWLETT PACKARD ENTERPRISE DEVELOPMENT LP, Spring, TX (US)

(72) Inventors: TODD MOY, Spring, TX (US); DEVEN PATEL, Santa Clara, CA (US); FARHAN HASNAIN, Santa Clara, CA (US)

(21) Appl. No.: 18/744,128

(22) Filed: Jun. 14, 2024

(51) Int. Cl. H04B 1/00; H04L 25/02

(52) U.S. Cl. CPC H04B 1/0078; H04B 1/0064; H04L 25/0214

(57) ABSTRACT

Systems and methods are provided for channel sounding techniques, such as High-Accuracy-Distance-Measurement (HADM), for phase-based ranging. By utilization of a coupler, antennas on a multi-radio device can be shared to provide the diversity for HADM, without affecting other radio functions. Examples include at least a first antenna coupled to a first radio. The first radio is configured to process signals received from a peripheral device via the first antenna. Examples also include a first radio coupled to a second antenna and configured to selectively receive signals from the peripheral device via the second antenna. The second radio is configured for a different communication technology than the first radio.

### BACKGROUND

Wireless communications devices may communicate with each other via one or more communications modalities, such as a wireless fidelity (Wi-Fi) connection or a Bluetooth connection. The wireless communication may be implemented in a manner compliant with a wireless communication protocol. Moreover, the wireless communications devices may include various hardware components to facilitate such communication according to corresponding wireless communication protocols. For example, wireless communications devices may include a Bluetooth radio and a Wi-Fi radio. The Bluetooth radio may facilitate wireless communications according to Bluetooth protocols and the Wi-Fi radio may facilitate wireless communication according to Wi-Fi protocols set forth in the IEEE 802.11 family of standards.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example of a network configuration that may be implemented in accordance with the present disclosure

FIG. 2 illustrates a block diagram of an example wireless communication system, in accordance with examples of the present disclosure.

FIG. 3 illustrates a channel sounding process 300, in accordance with examples of the present disclosure.

FIG. 4 illustrates an example method 400, in accordance with examples of the present disclosure.

FIG. 5 is an example computing component that may be used to implement various features of channel sounding in accordance with the implementations disclosed herein.

FIG. 6 is an example computer system that may be used to implement various features of channel sounding of the present disclosure.

The figures are not exhaustive and do not limit the present disclosure to the precise form disclosed.

### DETAILED DESCRIPTION

Channel sounding, also sometimes referred to as High-Accuracy-Distance-Measurement (HADM), is a phase-based ranging method defined in the Bluetooth (BT) protocols. Channel sounding can be leveraged by BT enabled devices to provide distance measurements between two BT enabled devices. If one of the BT enabled devices has knowledge of its latitude, longitude, and elevation coordinates, channel sounding can be used in conjunction with angle of arrival (AoA) and/or angle of departure (AoD) to calculate the latitude, longitude, and elevation coordinates of the second BT enabled device. This information can allow a system to locate these devices in geographical coordinates even in the absence of a Wi-Fi network, other wireless local area network (WLAN), or global positioning system (GPS) network. Examples of BT enabled devices can include any wireless communication device, such as, but not limited to, access points (APs), switches, gateways, laptops, cellular telephones, tags, beacons, Wi-Fi enabled client devices, and the like.

Channel sounding, according to examples, can be used to determine a distance between a source device and a peripheral device based on a phase difference between exchanged signals. For example, a single channel sounding event may include a source device transmitting a first signal, having a first phase, to the peripheral device encoded according to the BT protocols. The peripheral device receives the first signal, measures a second phase of the received signal, replicates the received signal, and transmits the replicated signal as a second signal, according to the BT protocol, having the second phase. The source device receives the second signal and measures a third phase. The source device may then determine the distance between itself and the peripheral device by executing a phase-based ranging measurement based on the phase difference between the first and third phases. By performing a number of channel sounding events by computing phase-based ranging measurements for a number of channel frequencies, a distribution of distance measurements can be obtained consisting of a number of distances. The number of distances can be aggregated to resolve a single value that is an estimate of representative of a real-world distance between the source device and peripheral device with high accuracy. The real-world distance may be unknown to at least the source device prior to any channel sounding events.

Wireless communication devices, such as access points (APs), client devices, etc., can comprise a number of antennas, each of which can be dedicated for a particular type of radio or shared amongst multiple radios. Each radio of the wireless communication device may be configured for a different wireless communication modality. That is, each radio may be configured for a particular wireless communication technology so to facilitate communications according to a corresponding wireless communication protocol. For example, a second radio may be configured as a Wi-Fi radio to facilitate communications using Wi-Fi protocols set forth in the IEEE 802.11 family of standards and a first radio may be configured as a BT radio to facilitate communications using BT protocols, including the more recent Bluetooth Low Energy (BLE) protocol, set forth in IEEE 802.15.4. A number of antennas may be dedicated for use with the BT radio (referred to as BT antennas), such that the BT radio can receive signals encoded according to BT protocols via the BT antennas, and perform operations according to BT standards. At the same time, another set of antennas can be dedicated for use with the Wi-Fi radio (referred to as Wi-Fi antennas), such that the Wi-Fi radio can receive signals encoded according to the Wi-Fi protocols via the Wi-Fi antennas and perform operations according to Wi-Fi protocols.

Conventionally, HADM is performed by measuring phases of signals encoded according to the BT protocols received at the BT radio. As such, conventional devices have used BT antennas to provide such signals to the BT radio. However, multipath interference or fading can cause challenges in determining distances from phase measurements. For example, multipath interference can give rise to the multipath effect (e.g., signal arriving an antenna by two or more paths) or fading (e.g., fluctuation in amplitude, phase or delay spread) that may can cause faulty distance measurements, for example, by altering the phase of a signal and/or decreasing the signal amplitude to a level that the BT radio is unable to read the signal (e.g., below a noise floor).

Increasing the number of channel sounding events (e.g., number of phase-based ranging measurements) can increase the diversity in the distance determinations, which can be used to mitigate the effects of fading and multipath interference. In some examples, the number of channel sounding events can be increased by channel sounding events for a number of channel frequencies within a frequency band on which a BT antenna is configured to operate. In this case, each channel sounding event obtains a distance measurement for a particular channel frequency. In another example, channel sounding events can be performed across multiple antennas, as well as multiple channel frequencies, thereby increasing the number of such events. In this case, multiple antennas may offer spatial diversity, as well as polarization diversity. More particularly, for example, multiple antennas can be positioned at different locations on an antenna plate of a wireless communication device. Each antenna may be able to detect signals under varying environmental conditions due to the spatial difference therebetween, thereby increasing the spatial diversity, and ultimately improving accuracy of the measured distance. As another example, antennas may be configured for different polarizations (e.g., vertical, horizontal, or any linear polarization alignment). Thus, signals having different polarization states (e.g., due to reflections or other environmental conditions) may be read by the antennas, thereby increasing diversity as well.

Accordingly, conventional devices have increased the number of BT antennas installed on a wireless communication so to enable increased diversity in the channel sounding events. However, adding additional BT antennas can require an increased physical footprint on the antenna plate of a wireless communication device so to fit each antenna, as well as provide for isolation requirements between each other. Antenna isolation refers to the technique of separating antennas that coexist within a particular wireless communication device so that acceptable levels of coupling exist between the antennas. For example, a 4×4 Tri-band Wi-Fi AP can have between eight to fifteen antennas on a single device. In an illustrative example, such an AP can be built into an enclosure that is less than 300 mm by 300 mm in size and having an antenna plate of 220 mm by 220 mm. BT antennas mounted on the antenna plate may consume, for example, an area of 40 mm by 40 mm, which translates 4% of the area of the antenna plate surface. While the physical space required for each BT antenna may be relatively small, the amount of area required to achieve desirable antenna isolation (e.g., 20 dB in this example) from neighboring antennas operating in the same frequency band may be relatively large. For example, to achieve 20 dB isolation between two antennas having the same polarization with 3 dBi gain and operating on the 2.4 GHz band, the antennas may need to be separated by 200 mm. For radial isolation, each antenna may require approximately 65% of the area of the antenna plate surface. Accordingly, adding even one additional antenna may negatively impact isolation or require an increased physical footprint of the antenna plate.

Examples of the present disclosure can enable performing channel sounding using a reduced number of antennas installed on a wireless communication device. For example, implementations disclosed herein may leverage one or more antennas, dedicated for (e.g., associated with or otherwise corresponding to) a second radio configured to facilitate communications according to a second communication technology, to detect signals encoded according to first communication technology, for performing a channel sounding event. The one or more antennas can be selectively coupled to a first radio, configured to facilitate communications according to a first communication technology, so to provide a portion of detected signals to the first radio, without impacting operation of the second radio. In examples, the signal detected by the one or more antennas may be composite signals containing signals encoded according to a protocol of the second communication technology and signals encoded according to a protocol of the first communication technology. During operation, the first radio may receive a portion of the composite signal due to the selective coupling, while the second radio receives the remaining portion. Both radios process the composite signal according to their corresponding communication technology, which means the first radio may process only the part of the composite signal encoded to the protocol of the first communication technology and the second radio may process only the part of the composite signal encoded according to the protocol of the second communication technology. Thus, both radios can process signals simultaneously or near simultaneously, providing uninterrupted operation of the second radio.

The first radio can perform a channel sounding event using the signals detected by the one or more antennas (e.g., the portion of the detected signals coupled to the first radio). For example, the first radio may measure a phase of the portion of the detected signal. The measured phase may be used to perform a phase-based ranging measurement for the channel sounding event. For example, prior to receiving the detected signals, the first radio may have transmitted a signal having at an initial phase. The first radio may perform a phase-based ranging measurement based on a comparison of the measured phase against the initial phase. In examples, the comparison may be achieved by computing a phase difference between the measured phase and the initial phase.

In examples, the one or more antennas associated with the second radio may be configured to support transmissions/receptions of radio frequency (RF) signals in the 2.4 GHz industrial, scientific, and medical (ISM) frequency band. Another one or more antennas may be associated with (e.g., dedicated for or otherwise corresponding to) the first radio, and may also be to support transmissions/receptions of RF signals in the 2.4 GHz ISM frequency band. Thus, by supporting a common frequency band, each of the antennas may receive communications of either (or any other) communication technology encoded onto signals exchanged over the common frequency band. In examples, the second radio may be a Wi-Fi radio and the first radio may be a BT radio.

In an illustrative example, the present disclosure provides for a wireless communication device that includes at least a first antenna coupled to a second radio and a first radio configured to perform channel sounding (e.g., HADM) using at least signals detected on the first antenna. In this example, the second radio may be configured to process signals received from a peripheral device via the first antenna. The first radio may be coupled to the first antenna and configured to selectively receive signals from the peripheral device via the first antenna. The first radio may be configured for performing a first phase-based ranging measurement based on signals detected via the first antenna. The first radio may be configured for a different communication technology than the second radio. In an illustrative example, the second radio is a Wi-Fi radio and the first radio is a BT radio.

In some examples, the wireless communication device may include a first coupler disposed between the first antenna and the second radio. A first port of the first coupler can be connected to the first antenna (referred to herein as an “antenna port”) and a second port of the first coupler can be connected to the second radio (referred to herein as a “through port”). The first radio can be coupled to a third port of the first coupler (referred to herein as a “coupled port”), such that the first coupler outputs a portion of signals read by the first antenna to the first radio. In some examples, the wireless communication device may include a plurality of antennas, including the first antenna, and a plurality of couplers each disposed between a respective antenna of the plurality of antennas and the second radio. The plurality of antennas, in some examples, may be Wi-Fi antennas.

The wireless communication device may also include a second antenna corresponding to the first radio. In examples, the second antenna may be a BT antenna. The wireless communication device may include a plurality of antennas corresponding to the first radio (e.g., a plurality of BT antennas). A switch may be disposed between the first radio and the first coupler. In this case, the switch may comprise a radio connection point connected to the first radio and a plurality of antenna connection points. The plurality of antenna connection points may comprise a first antenna connection point connected to the second antenna and a second antenna connection point connected to the coupled port of the first coupler. The plurality of antenna connection point may comprise more antenna connection points depending on the number of couplers, as well as the number of antennas corresponding to the first radio (e.g., a distinct antenna connection point for each coupler and each BT antenna).

While the examples disclosed herein may refer inputs and outputs, such references are intended only for illustrative purposes. In the context of a wireless communication devices receiving a signal, the terms “input” and “output” may be used herein to indicate a signal flow and direction. For example, the wireless communication device may receive a signal as an input from another device (or component of the wireless communication device) which outputs a signal to a downstream device (or component of the wireless communication device). In the context of transmission from the wireless communication device, the terms “input” and “output” can be interchanged as reciprocal.

The wireless communication device may be configured to perform channel sounding based on operating the switch to selectively couple or otherwise connect the first radio to each antenna port. For example, in a first configuration, the wireless communication device may control the switch to connect the first antenna to first radio via the first coupler and execute channel sounding according to signals transmitted and received via the first antenna. The wireless communication device may obtain phase-based ranging measurements a number channel sounding events across a range of channel frequencies within the frequency band at which the first antenna is configured to support. The phase-based ranging measurements can be stored in a memory as a first set of phase-based ranging measurements. The wireless communication device may then configure itself into a second configuration by operating the switch to disconnect the first antenna and connect the second antenna to the first radio. In the second configuration, the wireless communication device can use the second antenna to obtain phase-based ranging measurements. As with the first antenna, the wireless communication device may perform a number of channel sounding events across a range of channel frequencies within the frequency band at which the second antenna is configured to support. The phase-based ranging measurements obtained for each channel sounding event can then be stored to memory as a second set of phase-based ranging measurements. In examples, the frequency band of the second antenna may be the same frequency band as that of the first antenna. The wireless communication device may perform the above operation iteratively for each antenna connected to the switch so to obtain respective sets of phase-based ranging measurements for each antenna.

In examples, each set of phase-based ranging measurements can contain a distribution of such measurements. One or more sets of phase-based ranging measurements can be merged to provide a distribution of phase-based ranging measurements with increased diversity relative to a single set. One or more sets can be aggregated, according to any aggregation function (e.g., mean, average, summation, rolling average, weighting, etc.), to resolve a distance value that may be a highly accurate estimate of the real-world distance between the wireless communication device and peripheral device.

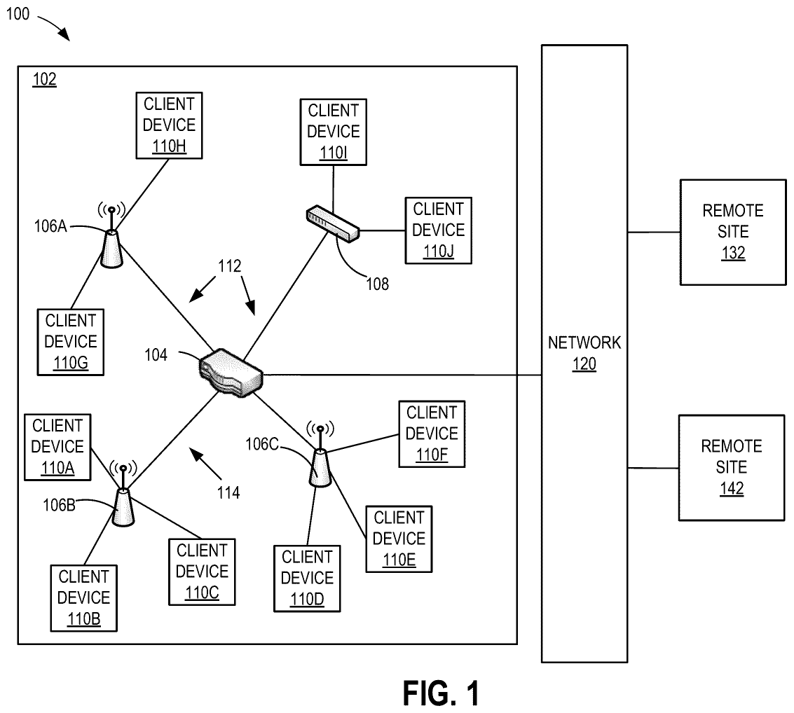

Before describing embodiments of the disclosed systems and methods in detail, it is useful to describe an example network installation with which these systems and methods might be implemented in various applications. FIG. 1 illustrates one example of a network configuration 100 that may be implemented for an organization, such as a business, educational institution, governmental entity, healthcare facility or other organization. FIG. 1 illustrates an example of a configuration implemented with an organization having multiple users (or at least multiple client devices 110) and possibly multiple physical or geographical sites 102, 132, 142. The network configuration 100 may include a primary site 102 in communication with a network 120. The network configuration 100 may also include one or more remote sites 132, 142, that are in communication with the network 120. Each remote site may comprise any number of wireless communication devices.

The primary site 102 may include a primary network, which may be an office network, home network, or other network installation, for example. The primary network may be a private network, such as a network that may include security and access controls to restrict access to authorized users of the private network. Authorized users may include employees of a company at primary site 102, residents of a house, customers at a business, for example.

In the example of FIG. 1, the primary site 102 includes a controller 104, which is in communication with the network 120. The controller 104 may provide communication with the network 120 for the primary site 102. There may be other points of communication with the network 120 for the primary site 102 in addition to controller 104. Although single controller 104 is illustrated, the primary site 102 may include multiple controllers and/or multiple communication points with network 120. In some embodiments, the controller 104 may communicate with the network 120 through a router. In other embodiments, the controller 104 provides router functionality to the devices in the primary site 102. In this specification, the word “tunnel” refers to an encapsulated mode of transporting data between AP and controller.

The controller 104 may be operable to configure and manage wireless communication devices, such as at the primary site 102, and may also manage wireless communication devices at the remote sites 132, 142. The controller 104 may be operable to configure and/or manage switches, routers, access points, and/or client devices connected to a network. The controller 104 may itself be, or provide the functionality of, an Access Point (AP).

The controller 104 may be in communication with one or more switches 108 and/or wireless Access Points (APs) 106a-c. Switches 108 and wireless APs 106a-c provide network connectivity to various client devices 110a-j. Using a connection to a switch 108 or AP 106a-c, a client device 110a-j may access network resources, including other devices on the (primary site 102) network and the network 120. The one or more switches 108, wireless APs 106a-c, and/or client devices 110a-j may be examples of wireless communication devices.

Examples of client devices may include: desktop computers, laptop computers, servers, web servers, authentication servers, authentication-authorization-accounting (AAA) servers, domain name system (DNS) servers, dynamic host configuration protocol (DHCP) servers, internet protocol (IP) servers, virtual private network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, internet of things (IOT) devices, and the like.

Within the primary site 102, a switch 108 is included as one example of a point of access to the network established in primary site 102 for wired client devices 110i-j. Client devices 110i-j may connect to the switch 108 and through the switch 108, may be able to access other devices within the network configuration 100. The client devices 110i-j may also be able to access the network 120, through the switch 108. The client devices 110i-j may communicate with the switch 108 over a wired or wireless connection 112. In the illustrated example, the switch 108 communicates with the controller 104 over a wired or wireless connection 112.

Wireless APs 106a-c are included as another example of a point of access to the network established in primary site 102 for client devices 110a-h. Each of APs 106a-c may be a combination of hardware, software, and/or firmware that is configured to provide wireless network connectivity to wireless client devices 110a-h. In the example of FIG. 1, APs 106a-c can be managed and configured by the controller 104. APs 106a-c communicate with the controller 104 and the network over connections 112, which may be either wired or wireless interfaces.

The network configuration 100 may include one or more remote sites 132. A remote site 132 may be located in a different physical or geographical location from the primary site 102. In some cases, the remote site 132 may be in the same geographical location, or possibly the same building, as the primary site 102, but lacks a direct connection to the network located within the primary site 102. Instead, remote site 132 may utilize a connection over a different network, e.g., network 120. A remote site 132 such as the one illustrated in FIG. 1 may be a satellite office, another floor or suite in a building, for example. The remote site 132 may include a gateway device (not shown), such as a router, a digital-to-analog modem, a cable modem, a digital subscriber line (DSL) modem, or some other wireless communication device, for communicating with the network 120. The remote site 132 may also include a switch and/or AP in communication with the gateway device over either wired or wireless connections. The switch 138 and AP 136 provide connectivity to the network for various client devices.

In various embodiments, the network configuration 100 may include one or more smaller remote sites 142. Such a remote site 142 may represent, for example, an individual employee's home or a temporary remote office. The remote site 142 may also be in communication with the primary site 102, such that the client devices at the remote site 142 access network resources at the primary site 102, via one or more wireless communication devices, as if these client devices were located at the primary site 102. Once connected to the primary site 102, the remote site 142 may function as a part of a private network provided by the primary site 102

The network 120 may be a public or private network, such as the Internet, or other communication network to allow connectivity among the various sites 102, 130 to 142. The network 120 may include third-party telecommunication lines, such as phone lines, broadcast coaxial cable, fiber optic cables, satellite communications, cellular communications, and the like. The network 120 may include any number of intermediate wireless communication devices, such as switches, routers, gateways, servers, and/or controllers, which are not directly part of the network configuration 100 but that facilitate communication between the various parts of the network configuration 100, and between the network configuration 100 and other network-connected entities. The network 120 may include various content servers (not shown). The content servers may include various providers of multimedia downloadable and/or streaming content, including audio, video, graphical, and/or text content, or any combination thereof. The client devices 110a-j may request and access the multimedia content provided by the content servers.

In examples according to the present disclosure, wireless communication devices of network configuration 100 may need to rely on a highly accurate distance between themselves and other wireless communication devices of network configuration 100. For example, AP 106A may rely on distances between itself and client device 110G to render real-time location services (RTLS), indoor wayfinding, proximity detection, access to site 102, and other applications that rely on highly accurate distance measurements. To provide such applications, examples of the present disclosure provide for channel sounding techniques using a reduced number of antennas installed on wireless communication devices, such as AP 106A. For example, as will be described in greater detail below, the wireless communication devices may leverage one or more antennas, dedicated for a second radio configured to facilitate communications according to a second communication technology, detect signals by a first radio encoded according to first communication technology for performing a channel sounding events. The first radio can perform channel sounding events by detecting phases of signals detected by the one or more antennas and performing phase-based ranging measurements over a range of channel frequencies of a frequency band supported by the one or more antennas.

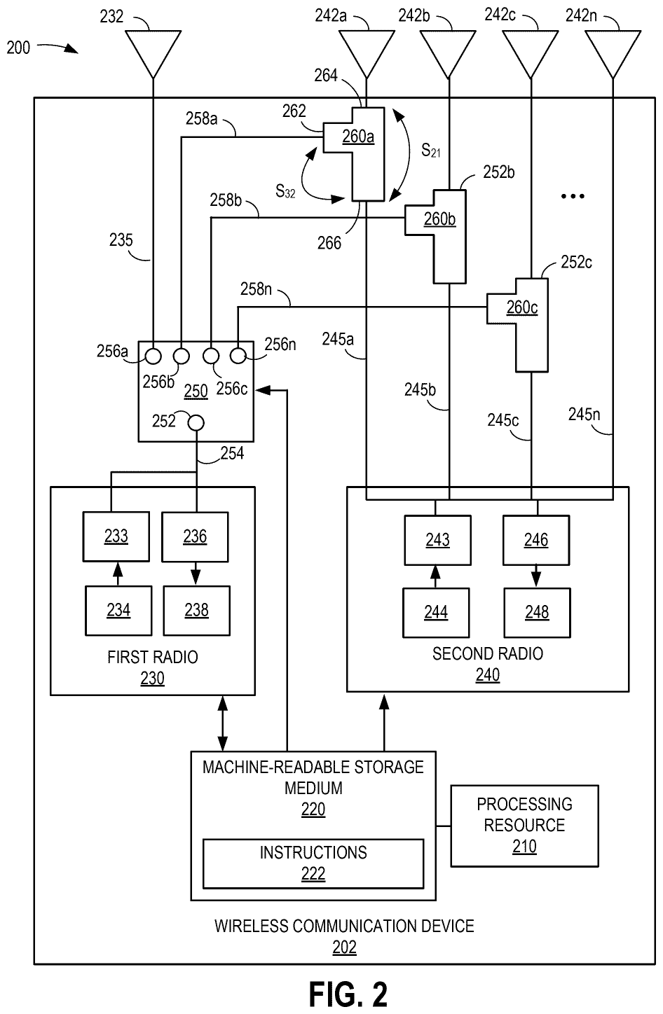

FIG. 2 illustrates a block diagram of an example wireless communication system 200, in accordance with examples of the present disclosure. The wireless communication device 202 includes at least one processing resource 210 and at least one machine-readable storage medium 220 comprising (e.g., encoded with) at least instructions 222 that are executable by the at least one processing resource 210 to implement functionalities described herein. The wireless communication device 202, according to examples herein, may be an example implementation of any of the wireless communication devices described above in connection with FIG. 1 (e.g., APs, switches, gateway devices, client devices, etc.).

In examples, wireless communication device 202 is configured for transmission and/or reception of single-band and multi-band wireless signals. For example, wireless communication device 202 includes a first radio 230 configured to facilitate communications according to a first wireless communication technology and a second radio 240 configured to facilitate communication according to a second wireless communication technology. According to examples, the first radio 230 is configured to transmit and receive signals for channel sounding and obtaining phase-based ranging measurements. In some examples, first radio 230 may be a single-band radio. In these examples, a phase-based ranging measurement may be considered a single-band ranging measurement.

The wireless communication device 202 also includes at least one antenna 232 dedicated to (e.g., corresponding to or otherwise associated with) the first radio 230. For example, antenna 232 can be coupled to the first radio 230 via antenna chain 235 (also referred to herein as an antenna link). In examples, the antenna chain can be a wired connection between the antenna 232 and the first radio 230. Antenna 232 can be configured to support a frequency band to detect or transmit or receive wireless signals from the first radio 230. In the example of FIG. 2, a single antenna 232 is depicted for illustrative purposes only. It will be understood that wireless communication device 202 may include any number of antennas coupled to the first radio via a respective antenna chain.

The wireless communication device 202 also includes one or more antennas dedicated to (e.g., corresponding to or otherwise associated with) the second radio 240. This is illustratively shown as antennas 242a-242n (referred herein to singularly as antenna 242 and collectively as antennas 242). For example, antennas 242a-242n can be coupled to the second radio 240 via respective antenna chains 245a-245n (also referred to herein as an antenna link). Antennas 242a-242n can be configured support a frequency band to detect or transmit and provide or receive wireless signals from the second radio 240. In examples, each antenna 242a-242n may support the same or a different frequency band as the other antennas 242a-242n. In the illustrative example of FIG. 2, antennas 242a-242c may support a frequency band common to each antenna, while antenna 242n may support a different frequency band. While the example shown in FIG. 2 includes four antennas 242, implementations disclosed herein are not limited to this example. Antennas 242 may comprise any number of antennas as desired (e.g., 1, 2, 3, 5, 6, etc.).

The first radio 230 may include a transmitter 233 configured to transmit signals provided by a modulating circuit 234 and a receiver 236 that is configured to receive modulated signals and provide the modulated signals to demodulating circuit 238 for processing. The antenna 232 may be configured to operate in a frequency band that the transmitter 233 is configured to transmit signals on and receiver 236 is configured to receive signals on. In some examples, the first radio 230 may be a BT radio that is configured to support transmission/reception of RF signals according to the BT protocols. In an example, the first radio 230 may be a BLE radio that is configured to support transmission/reception according to the BLE protocols.

In an example, the first radio 230 is configured to support the transmission and/or reception of RF signals in the 2.4 GHz ISM frequency band (also referred to herein simply as the 2.4 GHz band) via the transmitter 233 and/or receiver 236 (collectively referred to as a transceiver), respectively, according to the BT protocols. The first radio 230 can also be configured to process the signals to be transmitted and received signals at the modulating circuit 234 and/or demodulating circuit 238, respectively, according to the BT protocols. In this example, antenna 232 may be configure to support the 2.4 GHz frequency band. In some embodiments, the 2.4 GHz band may include a frequency range from 2.4 GHz to 2.5 GHz.

The second radio 240 may include a transmitter 243 configured to transmit signals provided by a modulating circuit 244 and a receiver 246 that is configured to receive modulated signals and provide the modulated signals to demodulating circuit 248 for processing. The antennas 242 may be configured to operate in one or more frequency bands that the transmitter 243 is configured to transmit signals on and receiver 246 is configured to receive signals on. In some examples, the second radio 240 may be a wireless local area network (WLAN) radio (sometimes referred to as, a Wi-Fi radio) that is configured to support the transmission/reception of RF signals in a plurality of frequency bands. In such examples, second radio 240 may operate at a frequency band within the range of 400 MHz to 7 GHz. For example, second radio 240 may operate at a 5 GHz band, which conforms to the IEEE 802.11 family of standards; a 2.4 GHz band, which conforms to IEEE 802.11 family of standards, or a combination thereof. In some examples, the second radio 240 may also operate at a frequency band within the range of 24 to 300 GHz. For example, the second radio 240 may operate at a 60 GHz band which conforms to one or both of the IEEE 802.11ad and 802.11ay standards. It will be understood by one skilled in the art that second radio 240 may transmit and receive wireless signals that conform to any suitable type(s) of wireless communications standard(s), now known or later developed, and/or operate at any suitable frequency range(s). In some examples, antennas 242a-242c may be configured to operate in the 2.4 GHZ band, while the antenna 242n may be configured to operate in a different band, such as but not limited to, a frequency band within the range of 24 to 300 GHz, a 60 GHz band, or any suitable frequency band according to the Wi-Fi standards. According to an illustrative example, antennas 242a-242c may be configured to operate at the same frequency band as antenna 232.

Each frequency band may refer to a range of frequencies that define a particular frequency band. Each frequency band may be further sub-divided into smaller ranges of frequencies, each referred to as channel frequency or channel.

In some examples, the wireless communication device 202 may include a number of band pass filters, amplifiers and analog-to-digital converters (ADCs) and digital-to-analog converters (DACs) within and through which signals can be passed between the antennas 232 and/or 242 and components of the wireless communication device 202.

In some examples, the antennas of the wireless communication device 202, including antennas 232 and 242, may be collectively referred to as an antenna array, which can be physically formed on an antenna plate (not shown). Components of the wireless communication device 202 and the antenna array can be integrally formed (e.g., deposed) or incorporated on a single integrated circuit (IC) chip. In some example, components of each antenna can be integrally formed on separate IC chips. In some embodiments, the components of the wireless communication device 202 and the antenna array may be mounted (e.g., attached) to the same or different printed circuit boards (PCBs) or substrates. The PCBs, substrates, and/or IC chip may be example implementations of the antenna plate.

As shown in FIG. 2, the wireless communication device 202 includes one or more couplers 260a-260c (referred herein to singularly as a coupler 260 and collectively as couplers 260) disposed between the second radio 240 and a respective antenna 242. For example, each coupler 260 may be attached at any location along a respective antenna chain 245. In examples, the couplers 260 can be passive devices that couple a portion of the signal received by a respective antenna 242a-242c to the first radio 230. In some examples, couplers 260 may be implemented as directional couplers or the like. Thus, signals received by each antenna 242a-242c can continue to the second radio 240 for uninterrupted processing by the components of the second radio 240.

For example, with reference to coupler 260a as an illustrative example of each coupler 260, coupler 260a includes an antenna port 264, a through port 266, and a coupled port 262. The antenna port 264 can be connected to antenna 242a and through port 266 can be connected to the second radio 240. Coupled port 262 can be coupled to first radio 230 via switching element 250. The antenna port 264 to through port 266 can provide a through path that passes signals at antenna port 264 to the through port 266, and ultimately to the second radio 240. The antenna port 264 to coupled port 262 can provide a coupling path that samples a signal on the antenna chain 245a by a factor equal to a coupling factor of the coupler 260a. Thus, coupler 260a can operate to passively sample (e.g., split) a portion of a signal detected by the antenna 242a, destined for second radio 240, to the first radio 230. At the same time or near same time, the second radio 240 (e.g., receiver 246) can sample signals at the through port 266 for uninterrupted processing by the components of the second radio 240. The amount of the signal sampled by the coupled port 262 may be set to any desired amount. In an illustrative example, 10% or less of the signal at the antenna port 264 may be sampled by the coupled port 262, as long as the signal received by the first radio 230 is distinguishable from a noise floor. In an example, the coupled port 262 can have 10 dB attenuated signal of the signal at the antenna port 264, that is for example, 10% of the signal at the antenna port 264. In this example, 90% of the signal at the antenna port 264 is passed through the coupler 260 and provided to the second radio 240. The 0.5 dB of signal power loss due to the splitting by the coupler 260 may be negligible, which is why the second radio 240 can continue with unhindered operation. While coupler 260a is described in detail, each of coupler 260 may be configured in a similar manner as illustrated with respect to a respective antenna 242.

As alluded to above, the wireless communication device 202 may include a switching element 250 disposed between the first radio 230 and the antenna array. In the example of FIG. 2, the switching element 250 is attached to the antenna channel 235 between the antenna 232 and the first radio 230, as well as between the first radio 230 and couplers 260. In some examples, the switching element 250 may include a single connection point 252 (sometimes referred to herein as a “radio connection point”) connected to the first radio 230 via a link 254. The switching element 250 also includes plurality of connections point 256a-256n (sometimes referred to herein as an “antenna connection point”), each of which is connected to an antenna. For example, connection point 256a is connected to antenna 232 via antenna chain 235, connection point 256b is connected to coupler 260a (e.g., coupled port 262) via link 258a, connection point 256c is connected to coupler 260b (e.g., a coupled port) via link 258b, and connection point 256n is connected to coupler 260c (e.g., a coupled port) via link 258n. In an example implementation, switching element 250 may be a Single Pole M Throw switch, where M is the number of connection points 256a-256n. In examples, the number of connection points 256a-256n may correspond to the number of antennas included for channel sounding (e.g., four in this example). In the example of FIG. 2, switching element 250 is shown as a Single-Pole 4 Throw (SP4T) switch. In some examples, switching element 250 may can be absorptive, which can minimize reflections for unswitched legs of the switching element 250 back through the couplers 260a-260c.

The switching element 250 may be operated, for example, by processing resource 210 executing instructions 222, to selectively connect one of antennas 232 and 242a-242c to the first radio 230. That is, for example, switching element 250 may be operated to connect link 254 to antenna chain 235, thereby coupling antenna 232 to first radio 230, while isolating the first radio 230 from antennas 242a-242c. Switching element 250 may be operated to disconnect link 254 from antenna chain 235 and connection link 254 to another antenna chain (e.g., one of links 258a-258n) and coupled to a respective antenna chain 245a-245c. The operation may be repeated according to which antenna of the antenna array is desired to be coupled to the first radio 230.

In operation, according to the example of FIG. 2, wireless communication device 202 may be configured to perform channel sounding by operating the switching element 250 to selectively connect the first radio 230 to each antenna 232 and 242a-c. By selectively connecting antennas, the wireless communication device can obtain a set of phase-based ranging measurements from each antenna.

For example, to achieve a first configuration, the processing resource 210 may execute instructions 222 to control the switching element 250 to connect the antenna 242a to first radio 230 via the coupler 260a. The processing resource 210 may execute instructions 222 to perform channel sounding events for a plurality of channel frequencies (e.g., a range of channel frequencies) within the frequency band at which the antenna 242a is configured to support (e.g., 2.4 GHz band in an example). The channel sounding events output phase-based ranging measurements that can be provided as a set of phase-based ranging measurements for the first configuration.

In an example sounding event, the wireless communication device 202 can obtain a phase-based ranging measurement for a single channel frequency. To do so, processing resource 210 may execute instructions 222 to cause the first radio 230 to generate an initial signal encoded according to the wireless communication protocol of the first radio 230 (e.g., BT protocols in an illustrative example) to coupler 260a. Coupler 260a supplies the initial signal to the antenna chain 264 via coupled port 262. The antenna 242a, connected to antenna port 264, transmits the initial signal to a peripheral device having a phase Φ₀. The peripheral device may be a remote device physically separate from the wireless communication device by a real-world distance.

The peripheral device, which may implemented as another instance of wireless communication device 202 or any device comprising a first radio similar to first radio 230, receives the initial signal and detects a phase Φ₁, which may have been shifted due to propagation of the initial signal. The peripheral device can then replicate the initial signal and retransmit (e.g., reflect) it back to the wireless communication device 202 having the phase Φ₁.

The antenna 242a may detect the replicated signal, which can be supplied to the antenna port 264 of coupler 260a. Coupled port 262 samples the replicated signal from the antenna chain 245a and provides a portion of the replicated signal to the first radio 230 via switching element 250. The first radio 230 can process the replicated signal, according to the wireless communication protocols of the first radio 230 (e.g., BT protocols an illustrative example), and measure a phase Φ₂ of the replicate signal, which may have been shifted due to propagation of the replicated signal. In examples, the first 230 may include a clock reference as part of or coupled to receiver 236, which can be used measure phase of a received signal, as known in the art.

Using phase Φ₀ and Φ₂, processing resource 210 may execute instructions 222 to compute a distance (d_{single_channel}) between the wireless communication device 202 and peripheral device as follows:

$${d}_{{single}_{channel}} = \frac{{φ}_{2 W} c}{4 π f} mod \frac{λ}{2} \qquad Eq . 1$$

where Φ_{2w} is the difference between phase Φ₀ and phase Φ₂ (e.g., Φ₀ minus Φ₂), f is the channel frequency, c is the speed of light, and λ is a wavelength of the signals, which may be the same for the initial and the replicated signals.

In examples, the wireless communication device 202 may be able to distinguish a distance of λ/2 due to the phase repeating after every λ/2 distance. For a 2.4 GHz signal, the distinguishable distance may be 6.25 cm. In examples, a second channel frequency can be used to improve the distinguishable range by subtracting a second phase-distance relation from the first. That is, for example, the wireless communication device 202 may tune the antenna 242a to a second channel frequency and perform a subsequent iteration of the signal exchange described above to obtain a second phase Φ_{2,2} for the second channel frequency, where the phase measured for the first channel frequency may be considered a first phase Φ_{2,1} for the second channel frequency. In this case, processing resource 210 may execute instructions 222 to compute a distance (d_{dual_channel}) between the wireless communication device 202 and peripheral device as follows:

$${d}_{{dual}_{channel}} = \frac{Δφ c}{4 πΔ f} mod \frac{c}{2 Δ f} \qquad Eq . 2$$

Where ΔΦ is the phase difference between phase Φ_{2.2} for the second channel frequency and phase Φ_{2.1} for the first channel frequency, Δf is the frequency difference between the first channel frequency (f₁) and the second channel frequency (f₂). This frequency difference can provide an effectively smaller transmit frequency that improves the distinguishable range of the distance. In examples, the second channel frequency should be chosen such that the frequency difference (Δf) is less than the first channel frequency (e.g., (Δf)<<f1). In examples, the frequency difference (Δf) may be any desired the frequency difference to achieve a desirable maximum range. In the case of BT, the frequency difference (Δf) may be 2, 4, 5, . . . 78 MHz.

The above process can be iteratively performed for each channel frequency in the frequency band supported by the antenna 242a. For example, after obtaining the phase Φ_{2.b} for the second channel frequency, the processing resource 210 may execute instructions 222 to tune the antenna 242a to a next channel frequency. Once tuned, the processing resource 210 may execute instructions 222 to repeat the above operation and obtain a phase Φ_{2,2+1} for the next channel frequency, which can be compared to the second phase Φ_{2,2} for the second channel frequency to obtain a next phase-based ranging measurement (e.g., a next d_{dual channel}). The processing resource 210 may execute instructions 222 to do this operation each channel frequency, thereby obtaining a set of phase-based ranging measurements for the antenna 242a.

The wireless communication device 202 can then be configured into a second configuration. For example, processing resource 210 may then execute instruction 222 to connect the first radio 230 to another antenna (e.g., any one of antennas 232, 242b, 242c in this example) by operating switching element 250. Once in the second configuration, processing resource 210 may then execute instruction 222 to obtain a set of phase-based ranging measurements for the other antenna, similar to the process described but for antenna 242a. Once the set of phase-based ranging measurements are obtained, the wireless communication device 202 can be configured into a next configuration by connecting yet another antenna to the first radio 230 via operation of switching element 250.

Each of the sets of the phase-based ranging measurements, obtained as described above, can comprise a distribution of phase-based ranging measurements. One or more of the distributions can be merged to provide a more diverse distribution of phase-based ranging measurements. One or more of the distributions, as well as the merged distribution, can be aggregated by the processing resource 210 executing instructions 222, according to an aggregation function (e.g., mean, average, summation, rolling average, etc.), to derive an estimate of the distance (and its associated confidence) representative of a real-world distance between the wireless communication device 202 and the peripheral device. The particular aggregation function utilized may be dependent on the specific application. In some examples, a single set of phase-based ranging measurements (e.g., a set from one antenna) may be aggregated to provide an estimate. In another example, a plurality of sets of phase-based ranging measurements may be aggregated. In yet another example, all sets of phase-based ranging measurements may be aggregated.

As shown in Eqs. 1 and 2, the computed distance between the wireless communication device and the peripheral device is not dependent on an amplitude of the exchanged signal, as long as the first radio 230 can demodulate the signal. Instead, the computed distance is dependent on phase and channel frequencies. Thus, first radio 230 need only receive a portion of a replicated signal detected by the antennas 242 to resolve a distance therefrom. This permits the majority of any signals detected by the antennas 242 to be passed through their respective couplers 260 to the second radio 240. Accordingly, second radio 240 may receive the remaining portion of signals detected by antennas 242 at the same time (or near same time) that first radio 230 receives a portion of the signals detected by antennas 242. The second radio 240 may then process these signals without interruption (e.g., without having a binary redirection of all signals detected by the antenna 242a to the first radio 230) and according to its normal operation (e.g., according to the wireless communication protocols of the second radio 240, such as Wi-Fi protocols in an illustrative example).

For example, antenna 242a (as well as antennas 242b and 242c) can be configured to support the same frequency band as antenna 232 (e.g., 2.4 GHz band in this example). As such, signals detected by the antenna 242a may comprise signals encoded according to wireless communication protocols of both the first and second radios 230, 240 (e.g., BT signals and Wi-Fi). Both radios 230 and 240 receive a portion of any signals detected by antenna 242a via coupler 260a according to the coupling factor of the coupler 260a. The portion received by second radio 240 may be larger than that received by first radio 230. Each radio 230 and 240 processes the respectively received signals encoded according its their respective wireless communication protocols. Thus, second radio 240 can operate without interruption, while the first radio 230 performs phase-based ranging measurement according to Eqs. 1 and/or 2 above. These separate processing operations can be executed simultaneously or near simultaneously.

Furthermore, by leveraging antennas dedicated to the second radio 240 for supplying signals to the first radio 230, the wireless communication device 202 can include a reduced number of antennas relative to conventional devices. That is, as described above, conventional devices utilized a plurality of antennas dedicated to a first radio for channel sounding. However, examples according to the present disclosure can perform channel sounding using antennas dedicated to another radio configured according to a different wireless communication technology. As such, the examples disclosed herein do not require any antenna be specifically dedicate to the first radio 230, at least for channel sounding. That is, for example, wireless communication device 202 could perform channel sounding without antenna 232, using only one or more of antennas 242a-242c. Thus, the physical area needed for mounting each antenna can be reduced due to a smaller number of antennas. Additionally, the reduced number of antennas can enable achieving desired isolation requirements by permitting larger distance separation between antennas.

Furthermore, distance separation may not be the only way to achieve isolation between radios 230 and 240. Isolation can be simulated by placing attenuating elements between each antenna. For example, referring to coupler 260a, the through port 266 to coupled port 262 can provide for radio isolation due to the high rejection (e.g., 20 dB to 60 dB) between these ports. As described above, coupler 260a is shown, in this example, as a three port device used to either sample and/or isolate signals. The through path formed from antenna port 264 to through port 266 can have negligible attenuation, while the though port 266 to coupled port 262 provides reverse isolation from any signal input to the coupled port and vice versa. In examples, this reverse isolation can be in the range of 20 to 60 dB, which is more than sufficient to mimic antenna-to-antenna isolation between radios.

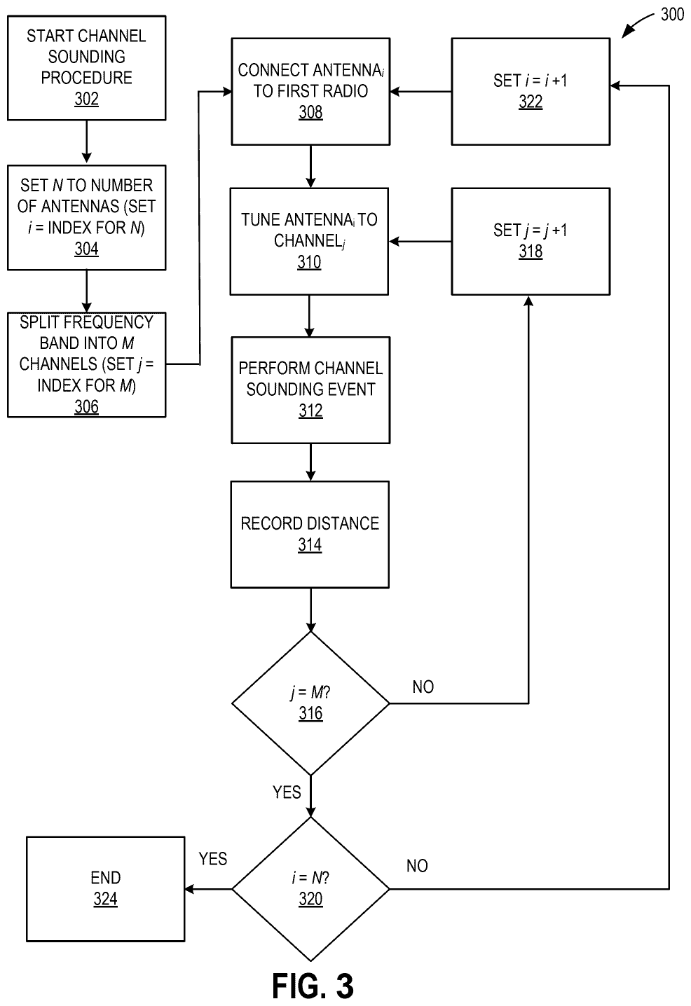

FIG. 3 illustrates a channel sounding process 300, in accordance with examples of the present disclosure. In an example, the operations of process 300 can be performed, for example, by a wireless communication system, such as wireless communication system 200 of FIG. 2. In an illustrative example, process 300 can be executed by wireless communication device 202 as a source device for performing process 300. Thus, for example, the operations of process 300 may be provided as instructions 222 in machine-readable storage medium 220 that can be executed by the processing resource 210. As such, the following description will be made with reference to FIG. 2 as an illustrative example.

The channel sounding process 300 can start at operation 302. In examples, operation 302 may include an initiating wireless communication device (referred to herein as an source device) requesting to establish a connection with a peripheral device according to a wireless communication protocol of the first radio 230. In an illustrative example, operation 302 may be performed by requesting establishment of a BT connection (such as, but not limited to, a BLE connection) with the peripheral device according to BT standards. The peripheral device may be a remote device physically separate from the wireless communication device by a real-world distance

Once a connection is established between the source and peripheral devices, the devices can exchange channel sounding capabilities and negotiate the configuration. In an example, once the configuration is negotiated between the source device and the peripheral device, channel sounding security, as set forth in the BT standards for channel sounding, can be enabled.

Negotiating the configuration can include performing operation 304 during which process 300 sets a number (N) of antennas to be used for the channel sounding process 300. The number of antennas set at operation 304 may be dependent on the number of antennas installed on the source device and configured to support a common frequency band. In the example of wireless communication device 202, operation 304 may set N=4, representing antennas 232 and 242a-242c. As described above, antennas 232 and 242a-242c may be configured to operate on the same frequency band (e.g., the 2.4 GHz band in an illustrative example). In some examples, the number set at operation 304 may be equal to or less than the number of antennas installed on the source device. At operation 304, an index i can be provided as a counter for the number (N) of antennas. Initially, i can be set to an index of the first antenna (e.g., 1).

Negotiating the configuration can also include performing operation 306 during which process 300 sets a number (M) of channel frequencies within a frequency band for channel sounding. For example, operation 306 may include splitting the common frequency band, described in operation 304, into a number (M) of channel frequencies. Operation 306 may also provide an index j as a counter for the number (M) of channel frequencies. Initially, j can be set to an index of the first channel frequency (e.g., 1). The channel frequencies at operation 306 may be a random or pseudo random set of channel frequencies across. Thus, while in some cases the number (M) of channel frequencies may be provided in a sequential order of channel frequencies, examples herein are not limited to a sequential order and can encompass any order as desired for a given implementation.

At operation 308, an i^{th} antenna may be connected to a first radio of the source device. For example, as described above in connection with FIG. 2, operation 308 may comprise operating switching element 250 to connect the first radio 230 to one of antennas 232 or 242a-242c. For illustrative purposes, during a first iteration (e.g., i=1), antenna 232 may be connected to the first radio 230. However, any of antennas 232 and 242a-242c may be connected for a first iteration depending on the desired operation.

At operation 310, the i^{th} antenna may be tuned to the j^{th} channel frequency. Referring to the above example, where during a first sub-iteration (e.g., j=1), the wireless communication device 202 may tune antenna 232 to a first channel frequency of the frequency band common to the antennas 232 and 242a-242c.

At operation 312, a channel sounding event is performed for the j^{th} channel frequency using the i^{th} antenna. For example, operation 312 can performed to obtain phase measurements and compute a phase-based ranging measurement based on the phase measurements. As an illustrative example, the first radio 230 may generate an initial signal that is transmitted by the antenna 232 via switching element 250. The initial signal may have a phase Φ₀. The peripheral device detects the initial signal having a phase Φ₁ and retransmits a replicated signal back to the wireless communication device 202. The antenna 232 detects the replicated (“reflected”) signal, which can be supplied to first radio 230. The first radio 230 can process the replicated signal to obtain a phase Φ₂ of the replicated signal. In one example, the wireless communication device 202 may compute a distance according to Eq. 1. Eq. 1 can be used for an initial channel sounding event (e.g., there are no prior phase measurements for the i^{th} antenna), such as during the first sub-iteration (e.g., j=1). The computed distance can be recorded into memory at operation 314, along with the obtained phases.

At operation 316, a determination is made as to whether the counter j for indexing channel stages has reached the number (M) of channel frequencies (e.g., j=M). If the counter j has not yet reached the number of channel frequencies, the process 300 can proceed to operation 318. At operation 314, the counter j is incremented. Incrementing the counter j can cause the process 300 to transition the next sub-iteration (e.g., channel frequency j+1). Process 300 can then repeat operations 310-314 for the i^{th} antenna, which can include performing a channel sounding event for the j+1 channel frequency and obtaining a phase measurement and a phase-based ranging measurement. In this sub-iteration, as well as subsequent sub-iterations, operation 312 may comprise computing the distance according to Eq. 2. In this case, the phase difference (ΔΦ) can be the phase Φ₂ for the current channel frequency minus the phase Φ₂ for the channel frequency of the previous sub-iteration. Similarly, the frequency difference (Δf) can be the current channel frequency minus the channel frequency of the previous sub-iteration. Operation 312 during each sub-iteration may also include computing a distance according to Eq. 1. Each phase and phase-based ranging measurement for each sub-iteration can be stored in memory at operation 314 as part of a set of measurements associated with the i^{th} antenna.

The process 300 repeats operations 310 through 318 until the counter j reaches the total number of channel frequencies, at which point the process 300 proceeds to operation 320. At operation 320, a determination is made as to whether the counter i for indexing antennas has reached the number (N) of antennas (e.g., i=N). If the counter i has not yet reached the number of antennas, the process 300 can proceed to operation 322. At operation 322, the counter i is incremented. Incrementing the counter i can cause the process 300 to transition the next iteration (e.g., antenna i+1).

Process 300 can then repeat operations 308-318 for the i+1^{th} antenna. For example, operation 308 for the next iteration may comprise operating switching element 250 to connect the first radio 230 to another of antennas 232 or 242a-242c. Referring to the example above, during a next iteration (e.g., i=2), switching element 250 may be operated to disconnect antenna 232 from first radio 230 and connect antenna 242a to the first radio 230. However, any antenna of antennas 232 or 242a-242c may be connected at a second iteration depending on the desired operation and which antenna was, as well as which antennas have been, connected during preceding iterations. During each sub-iteration of the second iteration (e.g., i=2), as described above in connection with FIG. 2, the first radio 230 may transmit/receive signals using antenna 242a via switching element 250 and coupler 260a. The wireless communication device 202 can obtain phases using signals exchanged over antenna 242a, which ultimately can be used to compute distances at operation 312 for each sub-iteration, as described above.

The process 300 repeats operations 308 through 322 until the counter i reaches the total number of antennas, at which point the process 300 ends at operation 324. As a result of the channel sounding process, a plurality of sets of measurements have been recorded in memory various instances of operation 314, each associated with a respective antenna. One or more of the sets of measurements can be merged together to provide a diverse distribution of distances computed at operation 312. This distribution may then be used to provide a highly accurate estimate of the real-world distance between the source device and the peripheral device. For example, operation 324 may include aggregating the distribution of distances according to a desired aggregation function. The aggregation function, which can be application specific, outputs a single value that is an estimate of the real-world distance between the source device and the peripheral device.

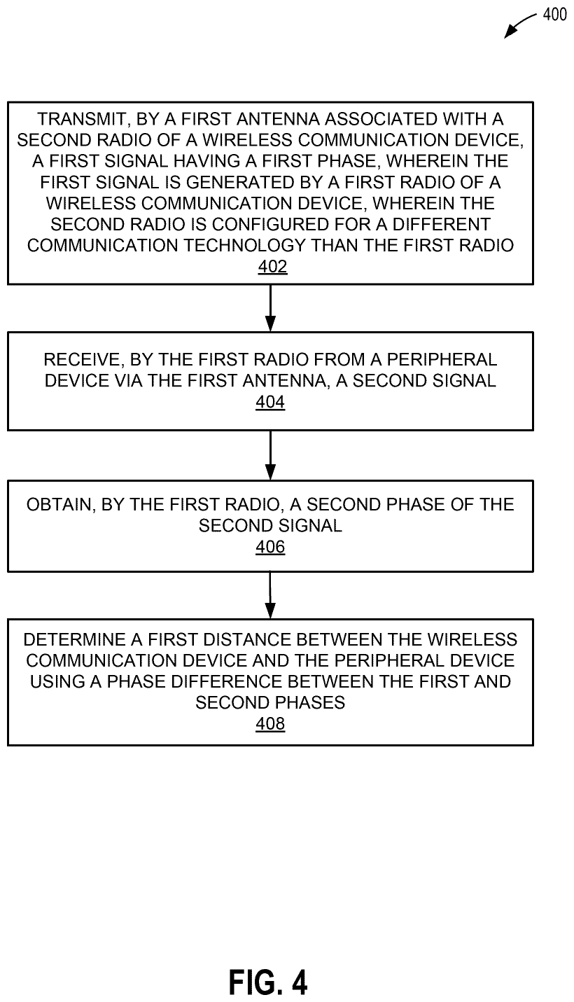

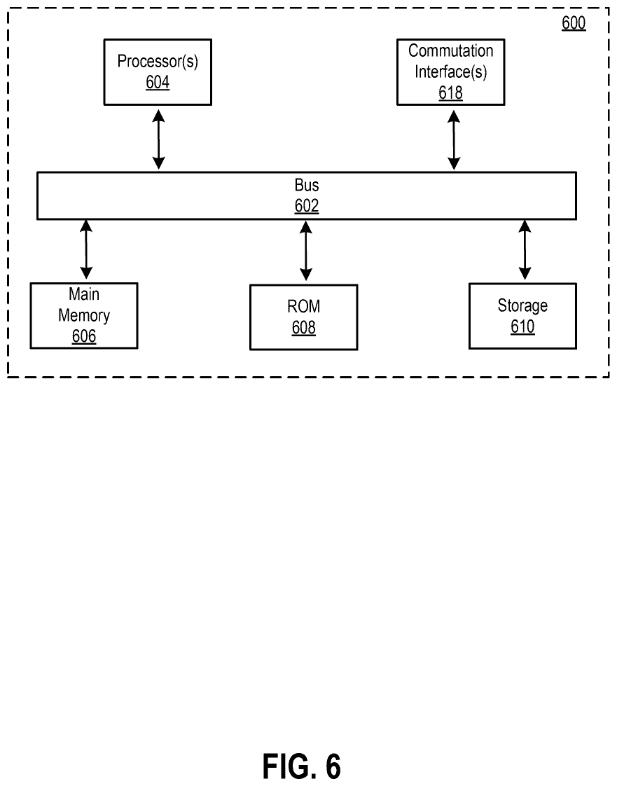

FIG. 4 illustrates an example method 400, in accordance with examples of the present disclosure. In an example, method 400 can be performed, for example, by a computing system, such as computer system 600 of FIG. 6. For example, the blocks of method 400 may be provided as instructions in memory that can be executed by a processor. In an illustrative example, method 400 may be performed by a wireless communication device 202. In an example, method 400 may include steps for a channel sounding event.

At block 402, a first signal having a first phase can be transmitted by a first antenna associated with a second radio of a wireless communication device. The first signal may be generated by a first radio of the wireless communication device. In an illustrative example, the wireless communication device may be implemented as wireless communication device 202 of FIG. 2 and the second radio and the first radio may be implemented as the first radio 230 and the second radio 240, respectively. In examples, the first antenna can be dedicated to or otherwise correspond to the second radio.

The first radio can be configured for a different communication technology than the second radio. For example, the first radio may be configured to facilitate communications using BT standards and, accordingly, configured to process signals encoded in BT protocols and encoded signals according to the BT protocols. In examples, the second radio may be configured to facilitate communications using Wi-Fi standards and, accordingly, configured to process signals encoded in Wi-Fi protocols and encoded signals according to the Wi-Fi protocols

At block 404, the first radio may receive a second signal from a peripheral device. The peripheral device may be a remote device physically separate from the wireless communication device by a real-world distance.

In an example, first radio receives the second signal by coupling the first radio to the first antenna. For example, the first radio can be coupled to the first antenna (e.g., one of antennas 242a-242c in an illustrative example) via a coupler (e.g., one of couplers 260a-260c in an illustrative example) disposed between the first antenna and the second radio. An antenna port of the coupler can be connected to the first antenna and a through port of the coupler can be connected to the second radio. The first radio can be coupled to a coupled port of the coupler, such that the coupler outputs a portion of the second signal received by the first antenna to the first radio, as described above in connection with FIGS. 2 and 3.

At block 406, a second phase of the second signal may be obtained. For example, the wireless communication device (e.g., the first radio) may detect or otherwise measure the second phase from the second signal.

At block 408, a first distance between the wireless communication device and the peripheral device can be determined using a phase difference between the first and second phases. For example, a first distance can be determined according to Eq. 1 above.

In an example, the first radio can be selectively coupled to the first antenna, for example, as described above in connection with FIGS. 2 and 3. For example, a switch (e.g., switching element 250), disposed between the first radio and the coupler, may be operated selectively connect and disconnect antennas from the first radio. In an illustrative example, the switch can be operated to disconnect the first antenna from the first radio and connect a second antenna to the first radio. The second antenna may be another one of antennas 232 and 242b-242c. The first and second antennas, according to examples, may be configured to operate on a common frequency band (e.g., the 2.4 GHz band).

In this example, a distance between the wireless communication device and the peripheral device can be determined based on signals received by the first radio via the second antenna. For example, the first radio may receive, from the peripheral device, a third signal via the second antenna. The third signal may be a retransmission, by the peripheral device, of another signal received by the peripheral device from the first radio. The first radio may then obtain a third phase of the third signal. The distance between the wireless communication device and the peripheral device can be determined based on the second and third phases, for example, according to Eq. 2 above.

In an example, the switch can be iteratively operated to selectively connect an antenna of a plurality of antennas to the first radio. Each antenna is configured to support a common frequency band, and the plurality of antennas includes the first antenna. For each antenna, a phase measurement of a signal received by the respective antenna can be iteratively obtained for each of a plurality of channel frequencies of the common frequency band and a set of distances between the wireless communication device and the peripheral device can be determined based the obtained phase measurements. A distribution of distances can be generated from the set of distances, for example by merging one or more of the sets of distances together.

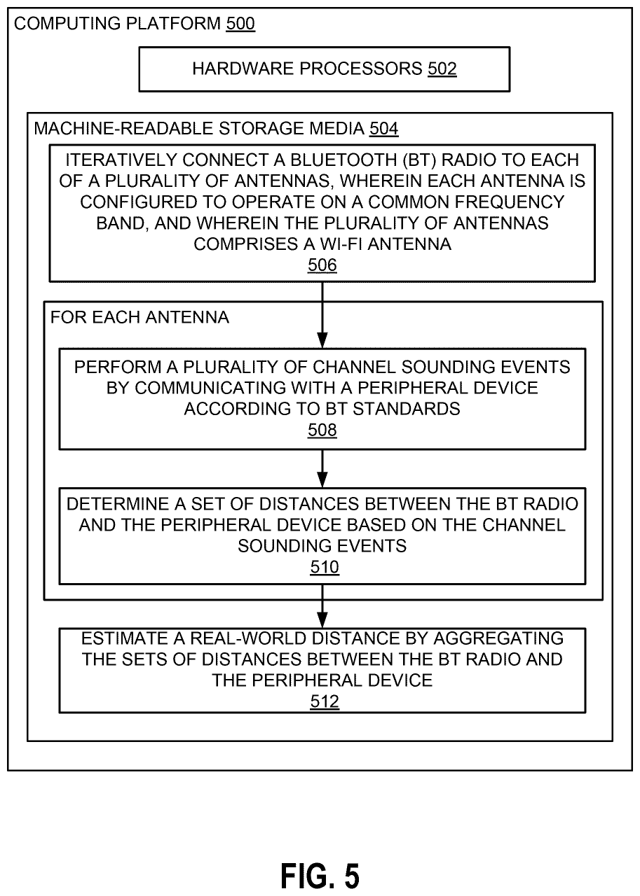

FIG. 5 illustrates an example computing component that may be used to implement channel sounding in accordance with implementations disclosed herein. Referring now to FIG. 5, computing component 500 may be, for example, a server computer, a controller, or any other similar computing component capable of processing data. In the example implementation of FIG. 5, the computing component 500 includes a hardware processor 502, and machine-readable storage medium for 504. In an example, computing component 500 may be included as part of or implemented as wireless communication device 202 of FIG. 2.

Hardware processor 502 may be one or more central processing units (CPUs), semiconductor-based microprocessors, and/or other hardware devices suitable for retrieval and execution of instructions stored in machine-readable storage medium 504. Hardware processor 502 may fetch, decode, and execute instructions, such as instructions 506-512, to control processes or operations for channel sounding. As an alternative or in addition to retrieving and executing instructions, hardware processor 502 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 504, may be any electronic, magnetic, optical, or other physical storage device that contains or stores executable instructions. Thus, machine-readable storage medium 504 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 504 may be a non-transitory storage medium, where the term “non-transitory” does not encompass transitory propagating signals. As described in detail below, machine-readable storage medium 504 may be encoded with executable instructions, for example, instructions 506-512.

Hardware processor 502 may execute instruction 506 to iteratively connect a BT radio to each of a plurality of antennas. Each antenna may be configured to operate on a common frequency band, and the plurality of antennas comprises a Wi-Fi antenna. In an example, the BT radio may be first radio 230 and the plurality of antennas may be antennas 232 and 242a-242c, for FIG. 2. In an example, instructions 506 may be executed to operate a switch (e.g., switching element 250) to iteratively connect the BT radio to each of the plurality of antennas, one at a time.

For each antenna, hardware processor 502 may execute instruction 508 to perform a plurality of channel sounding events by communicating with a peripheral device according to BT standards. For example, instruction 508 may include receiving a plurality of signals by a respective antenna from the peripheral device for a plurality of channel frequencies of the common frequency band. Instruction 508 may also include obtaining a plurality of phase measurements from the plurality of received signal.

For each antenna, hardware processor 502 may execute instruction 510 to determine a set of distances between the BT radio and the peripheral device based on the channel sounding events. For example, instruction 510 may include determining the set of distances for a respective antenna using the plurality of phase measurements obtained by instruction 508.

Hardware processor 502 may execute instruction 512 to estimate a real-world distance by aggregating the sets of distances between the BT radio and the peripheral device. For example, a subset or all of the sets of distances can be merged to provide a distribution of distance, which can be aggregated according to a desired aggregation function (e.g., mean, average, summation, rolling average, etc.) to resolve the estimate of the real-world distance. The particular aggregation function utilized may be dependent on the specific application.

In examples, during the channel sounding events for the Wi-Fi antenna, hardware processor 502 may also execute instructions to detect, by the Wi-Fi antenna, a composite signal comprising information encoded according to BT protocols and information encoded according to Wi-Fi protocols. The hardware processor 502 may also execute instruction to process a portion of the signal according to BT protocols to obtain phase measurements of the composite signal, which can be used to provide the set of distances between the BT radio and the peripheral device for the Wi-Fi antenna. The hardware processor 502 may also execute instructions to process the remaining portion of the composite signal by a Wi-Fi radio (e.g., second radio 240) according to Wi-Fi protocols.

FIG. 6 depicts a block diagram of an example computer system 600 in which various examples of the disclosed technology described herein may be implemented. The computer system 600 includes a bus 602 or other communication mechanism for communicating information, one or more hardware processors 604 coupled with bus 602 for processing information. Hardware processor(s) 604 may be, for example, one or more general purpose microprocessors. Computer system 600 may be included as part of or implemented as a wireless communication system 200 of FIG. 2 (e.g., as part of or implemented as a wireless communication device 202).

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions. In an example, main memory 606 may store instructions that can be executed by processor 604 for performing operations of the channel sounding process 300 of FIG. 3 and/or method 400 of FIG. 4. In some examples, main memory 606 may store one or more of the instructions described in connection with FIGS. 5 and 6.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

The computer system 600 also includes a communication interface 618 (also referred to as a network interface) coupled to bus 602. Communication interface 618 provides a two-way data communication coupling to one or more network links that are connected to one or more local networks. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN (or WAN component to communicated with a WAN). Wireless links may also be implemented. In any such implementation, communication interface 618 sends and receives electrical, electromagnetic or optical signals that carry digital data streams representing various types of information.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A wireless communication device comprising:
at least a first antenna connected to a second radio, the second radio configured to process signals received from a peripheral device via the first antenna; and
a first radio coupled to the first antenna and configured to selectively receive signals from the peripheral device via the first antenna, wherein the first radio is configured to perform a first phase-based ranging measurement based on signals received from the peripheral device via the first antenna,
wherein the second radio is configured for a different communication technology than the first radio.

2. The wireless communication device of claim 1, wherein the first radio is a Bluetooth Low Energy (BLE) radio and the second radio is a Wi-Fi radio.

3. The wireless communication device of claim 1, further comprising:
a first coupler disposed between the first antenna and the second radio, wherein an antenna port of the first coupler is connected to the first antenna and a through port of the first coupler is connected to the second radio,
wherein the first radio is coupled to a coupled port of the first coupler, and wherein the first coupler outputs a portion of the signals received by the first antenna to the first radio.

4. The wireless communication device of claim 3, further comprising:
a second antenna corresponding to the first radio; and
a switch disposed between the first radio and the first coupler, wherein the switch comprises an radio connection point connected to the first radio and a plurality of antenna connection points, wherein the plurality of antenna connection points comprises a first antenna connection point connected to the second antenna and a second antenna connection point connected to the coupled port of the first coupler,
wherein the switch is configured to selectively couple the first radio to each of the plurality of antenna connection points.

5. The wireless communication device of claim 4, wherein the first radio is configured to perform a second phase-based ranging measurement based on a phase difference between signals received from the peripheral device via the second antenna based on operation of the switch.

6. The wireless communication device of claim 4, wherein the second antenna and the first antenna are configured to operate on a common frequency band.

7. The wireless communication device of claim 6, wherein the common frequency band is a 2.4 GHz band.

8. The wireless communication device of claim 4, further comprising:
a plurality of antennas coupled to the second radio, wherein the plurality of antennas includes the first antenna and not the second antenna; and
a plurality of couplers including the first coupler, wherein each coupler of the plurality of couplers is disposed between one antenna of the plurality of antennas and the second radio,
wherein each of the plurality of antenna connection points of the switch is connected to an antenna of the plurality of antennas, and
wherein the first radio is configured to perform a plurality of phase-based ranging measurements based on signals received from the peripheral device via the plurality of antennas.

9. The wireless communication device of claim 8, wherein a distance between the peripheral device and wireless communication device is determined based on aggregating the plurality of phase-based ranging measurements.

10. A method, comprising:
transmitting, by a first antenna associated with a second radio of a wireless communication device, a first signal having a first phase, wherein the first signal is generated by a first radio of a wireless communication device, wherein the second radio is configured for a different communication technology than the first radio;
receiving, by the first radio from a peripheral device via the first antenna, a second signal;
obtaining, by the first radio, a second phase of the second signal; and
determining a first distance between the wireless communication device and the peripheral device using a phase difference between the first and second phases.

11. The method of claim 10, wherein the first radio is a Bluetooth Low Energy (BLE) radio and the second radio is a Wi-Fi radio.

12. The method of claim 10, wherein the first radio is coupled to the first antenna via a coupler disposed between the first antenna and the second radio, wherein an antenna port of the coupler is connected to the first antenna and an through port of the coupler is connected to the second radio,
wherein the first radio is coupled to a coupled port of the coupler, and wherein the coupler outputs a portion of the second signal received by the first antenna to the first radio.

13. The method of claim 12, further comprising:
operating a switch to disconnect the first antenna from the first radio and connect a second antenna to the first radio, wherein the switch is disposed between the first radio and the coupler; and
determining a second distance between the wireless communication device and the peripheral device based on signals received by the first radio via the second antenna.

14. The method of claim 13, wherein the second antenna and the first antenna are configured to operate on a 2.4 GHz band.

15. The method of claim 13, further comprising:
receiving, by the first radio from the peripheral device via the second antenna, a third signal;
obtaining, by the first radio, a third phase of the third signal; and
determining the second distance between the wireless communication device and the peripheral device based on the second and third phases.

16. The method of claim 10, further comprising:
iteratively operating a switch to selectively connect an antenna of a plurality of antennas to the first radio, wherein each antenna is configured to support a common frequency band, and wherein the plurality of antennas comprises the first antenna;
for each antenna,
iteratively obtaining a phase measurement of a signal received by the respective antenna for each of a plurality of channel frequencies of the common frequency band; and
determining a set of distances between the wireless communication device and the peripheral device based the obtained phase measurements; and
generating a distribution of distances based on the set of distances determined for each antenna.

17. The method of claim 16, further comprising:
resolving a distance between the peripheral device and wireless communication device by aggregating the distribution of distances, wherein the resolved distance is representative of a real-world distance between the peripheral device and wireless communication device.

18. A system, comprising:
a memory configured to store instructions; and
a processor configured communicatively coupled to the memory and configured to execute the instructions to:
iteratively connect a Bluetooth (BT) radio to each of a plurality of antennas, wherein each antenna is configured to operate on a common frequency band, and wherein the plurality of antennas comprises a Wi-Fi antenna;
for each antenna,
perform a plurality of channel sounding events by communicating with a peripheral device according to BT standards; and
determine a set of distances between the BT radio and the peripheral device based on the channel sounding events; and
estimate a real-world distance by aggregating the sets of distances between the BT radio and the peripheral device.

19. The system of claim 18, wherein processor is further configured to execute the instructions to, during the channel sounding events on the Wi-Fi antenna:
detect, by the Wi-Fi antenna, a composite signal comprising information encoded according to BT protocols and information encoded according to Wi-Fi protocols;
process, at the BT radio, a portion of the composite signal according to BT protocols to obtain phase measurements of the composite signal, wherein the set of distances between the BT radio and the peripheral device for the Wi-Fi antenna is based on the obtained phase measurements; and
process the remaining portion of the composite signal by a Wi-Fi radio according to Wi-Fi protocols.

20. The system of claim 18, wherein the plurality of channel sounding events comprises:
receiving a plurality of signals by a respective antenna from the peripheral device for a plurality of channel frequencies of the common frequency band; and
obtaining a plurality of phase measurements from the plurality of received signals,
wherein the set of distances for a respective antenna are determined using the plurality of phase measurements.
